(19) United States
(12) Patent Application Publication
(10) Pub. No.: US 2001/0032084 A1
(43) Pub. Date: Oct. 18, 2001

(54) Multimedia information structuring and application generating method and apparatus

(75) Inventor: Neil Day, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Ricoh Company, LTD, Tokyo (JP)

(21) Appl. No.: 09/799,012

(22) Filed: Mar. 6, 2001

(30) Foreign Application Priority Data
Mar. 15, 2000 (JP) 2000-072685

(51) Int. Cl. G10L 21/00

(52) U.S. Cl. 704/270.1

(57) ABSTRACT

An application generating method includes steps of a) acquiring multimedia information that includes at least two of video data, audio data, image data, and text data and that is described with a language for structuring information, b) acquiring a style sheet that includes a definition relating to a data display format of the multimedia information and a definition relating to data processing of the multimedia information, and c) generating an application of manipulating data of the multimedia information by processing the multimedia information with the style sheet. An application generating apparatus, system, and machine readable medium can implement the application generating method.

### CROSS-REFERENCE TO RELATED DOCUMENTS

The present document claims priority on and contains subject matter related to Japanese Patent Application No. 2000-072685 filed in the Japanese Patent Office on Mar. 15, 2000, and the entire contents of which are hereby incorporated herein by reference.

### BACKGROUND OF THE INVENTION

1. Field of the Invention

The present invention relates to a method and an apparatus for structuring multimedia information and generating an application of the multimedia information.

2. Discussion of the Background

In recent years, the quantity of audio/visual information used on the Internet has increased with accelerated velocity, and demand for technology for efficiently managing and processing audio/visual information has increased more than ever. For efficiently managing and processing audio/visual information, the audio/visual information needs to be expressed in a proper manner so that the information can be referenced, retrieved, or processed accurately and promptly.

MPEG-7 is known as a method of expressing audio/image information. In a process of standardization of MPEG-7, one object was to enable describing the meaning of data by marking the data with a tag. DDL (Description Definition Language) of MPEG-7 is a description language that can describe the meaning of data of audio/image information in such a way.

HTML (Hyper Text Markup Language) is also known as a representative language in which data is marked by a tag. However, HTML does not have a capability of expressing audio/image information in a descriptive manner.

XML (Extensible Markup Language) promoted by W3C (World Wide Web Consortium) has its object to enable SGML (Standard Generalized Markup Language) to be used in the Internet as HTML is used, and greatly differs from HTML in that the user can define a tag. That is, in XML, by enclosing both ends of information with a tag defining a specific meaning in a document, the information is correlated to the specific meaning.

XML is a powerful language applicable to audio/image information also. DDL of MPEG-7 and XML are almost identical except that DDL provides a more plentiful variety of expanding sets.

DDL and XML are the languages that structure information. When displaying a structured document described with DDL or XML on a screen, for defining a style of displaying the document on the screen, a style sheet describing a display setting can be used. DSSSL (Document Style Semantics and Specification Language) of ISO standard 10179 and XSL (Extensible Style-sheet Language) of W3C are known as examples of the style sheet.

When displaying a document described with XML in a style set by XSL, a description of information contents and a display setting for the description of information contents are provided in separate files. That is, two kinds of files, (1) an XML description file describing information contents with XML and attaching a tag to the information contents to describe the meaning of the information contents and (2) an XSL file defining a display rule, are provided. Thereby, without changing the XML file, which includes information contents, itself, the XSL file defining a display rule can be overwritten.

### SUMMARY OF THE INVENTION

Conventionally, a style sheet as represented by XSL has been related only to a display layout for text data. However, the present inventors have recognized that for expressing audio/image information with DDL or XML so that the information can be efficiently managed and processed, it is desired that the concept of a style sheet is extended so that the style sheet can be also applied to audio/image information.

The present invention has been made in view of the above-discussed and other problems and addresses the above-discussed and other problems.

According to a preferred embodiment of the present invention, an application generating method includes steps of a) acquiring multimedia information that includes at least two of video data, audio data, image data, and text data and that is described with a language for structuring information, b) acquiring a style sheet that includes a definition relating to a data display format of the multimedia information and a definition relating to data processing of the multimedia information, and c) generating an application of manipulating data of the multimedia information by processing the multimedia information with the style sheet.

Thus, in the present invention, an application of manipulating data of multimedia information is generated according to a style sheet that includes a definition relating to a display format for data of the multimedia information and a definition relating to processing of data of the multimedia information. Accordingly, contents of the multimedia information, and processing and a displaying format of the multimedia information, can be separately managed from each other, such that even when changing the application by necessity, the change can be realized only by changing the style sheet that defines processing and a displaying format for the multimedia information as necessary without changing a file containing the contents of the multimedia information. By thus expanding the concept of a style sheet to displaying and processing of multimedia information, efficient generation of an application of multimedia information is realized, and thereby efficient management and processing of multimedia information can be realized.

In the above-described method, the steps of a), b), and c) may generate a plurality of applications of manipulating data of multimedia information for a plurality of combinations of multimedia information and style sheets. In this case, the method further includes receiving a user request, and selecting an application based on the user request among from the plurality of applications.

By thus processing multiple combinations of multimedia information and style sheets in advance, a user request can be quickly responded.

The above-described method may alternatively include receiving a user request, and in the steps of a) and b), multimedia information and a style sheet based on the user request may be respectively acquired.

Thus, in the present invention, multimedia information and a style sheet can be acquired one by one according to a user request, such that the multimedia information and the style sheet can be managed while maintaining separation of the multimedia information and the style sheet, and thereby efficient management and processing of the multimedia information can be realized

Further, in the above-described method, the step of b) may include searching for a style sheet based on a user request, and generating a new style sheet when the style sheet based on the user request is not found.

Therefore, in the present invention, when a style sheet is not found in response to a user request, a new style sheet is generated, such that accumulation of style sheets is realized and thereby plentiful applications can be accumulated.

Furthermore, the above-described method may include displaying the application in a browser used by a user, and executing the data processing defined by the style sheet in based on an operation by the user relative to the application.

Therefore, in the present invention, an application generated according to a style sheet can be provided to a user so as to be immediately executed by the user.

According to another preferred embodiment of the present invention, an application generating apparatus includes a multimedia information acquiring mechanism configured to acquire multimedia information that includes at least two of video data, audio data, image data, and text data and that is described with a language for structuring information, a style sheet acquiring mechanism configured to acquire a style sheet that includes a definition relating to a data display format of the multimedia information and a definition relating to data processing of the multimedia information, and an application generating mechanism configured to generate an application of manipulating data of the multimedia information by processing the multimedia information with the style sheet.

In the above-described apparatus, the multimedia information acquiring mechanism, the style sheet acquiring mechanism, and the application generating mechanism may be configured so as to generate a plurality of applications of manipulating data of multimedia information for a plurality of combinations of multimedia information and style sheets. In this case, the apparatus further includes a user request receiving mechanism configured to receive a user request, and an application selection mechanism configured to select an application based on the user request from among the plurality of applications.

The above-described apparatus may alternatively be configured so as to include a user request receiving mechanism configured to receive a user request and such that the multimedia information acquiring mechanism and the style sheet acquiring mechanism acquire multimedia information and a style sheet based on the user request.

Further, in the above-described apparatus, the style sheet acquiring mechanism may include a style sheet searching mechanism configured to search for a style sheet based on a user request, and a new style sheet generating mechanism configured to generate a new style sheet when the style sheet based on the user request is not found.

The above-described apparatus may further include a displaying mechanism configured to display the application in a browser used by a user, and a data processing executing mechanism configured to execute the data processing defined by the style sheet based on an operation by the user relative to the application.

According to another preferred embodiment of the present invention, a system includes a server configured to acquire multimedia information that includes at least two of video data, audio data, image data, and text data and that is described with a language for structuring information and a style sheet that includes a definition relating to a data display format of the multimedia information and a definition relating to data processing of the multimedia information, and a client configured to send a request to the server and to display an application of manipulating data of the multimedia information received from the server in accordance with data received from the server in response to the request. The application is generated by processing the multimedia information with the style sheet.

In the above-described system, the server may generate the application by processing the multimedia information with the style sheet, and send the application to the client.

Alternatively, the above-described system may be configured such that the client receives the multimedia information from the server and the style sheet and then processes the multimedia information with the style sheet.

Further, the above-described system may be configured such that the server receives the multimedia information from a remote server.

According to another preferred embodiment of the present invention, an information structuring method includes recording a style sheet for multimedia information including at least two of video data, audio data, image data, and text data and described with a language for structuring information. The style sheet includes a definition relating to a data display format of the multimedia information and a definition relating to data processing of the multimedia information.

According to another preferred embodiment of the present invention, an information structuring apparatus includes a unit configured to record a style sheet for multimedia information including at least two of video data, audio data, image data, and text data and described with a language for structuring information. The style sheet includes a definition relating to a data display format of the multimedia information and a definition relating to data processing of the multimedia information.

According to another preferred embodiment of the present invention, a machine readable recording medium records therein a program controlling a computer to execute steps of acquiring multimedia information that includes at least two of video data, audio data, image data, and text data and that is described with a language for structuring information, acquiring a style sheet that includes a definition relating to a data display format of the multimedia information and a definition relating to data processing of the multimedia information, and generating an application of manipulating data of the multimedia information by processing the multimedia information with the style sheet.

According to another preferred embodiment of the present invention, a machine readable recording medium records therein a style sheet that controls a computer to generate an application by executing steps of setting a data display format of multimedia information including at least two of video data, audio data, image data, and text data and described with a language for structuring information, and setting data processing of the multimedia information.

### BRIEF DESCRIPTION OF THE DRAWINGS

A more complete appreciation of the present invention and many of the attendant advantages thereof will be readily obtained as the same becomes better understood by reference to the following detailed description when considered in conjunction with accompanying drawings, wherein:

FIG 1 a diagram illustrating a client/server system using an audio/visual style sheet of the present invention;

FIG. 2 is a diagram for explaining an operation of providing an audio/visual contents description application by processing an audio/visual contents description document and an audio/visual style sheet;

FIG. 3 is a flowchart illustrating an operation of the client server system of FIG. 1;

FIG. 4 is a diagram for explaining another operation of the client server system of FIG. 1;

FIG. 5 is a diagram illustrating an example of generating an audio/visual contents description application by a combination of an audio/visual contents description document and an audio/visual style sheet;

FIG. 6 is a diagram illustrating another example of generating an audio/visual contents description application by a combination of an audio/visual contents description document and an audio/visual style sheet;

FIG. 7 is a diagram illustrating an example of an audio/visual contents description application generated by a combination of an audio/visual contents description document and an audio/visual style sheet;

FIG. 8 is a diagram illustrating another example of generating an audio/visual contents description application by a combination of an audio/visual contents description document and an audio/visual style sheet, in particular illustrating an image retrieval application capable of performing an image retrieval operation illustrated in FIG. 7;

FIG. 9 is a diagram for explaining an operation of setting a title by manipulating a search options button;

FIG. 10 is a diagram illustrating concrete examples of an audio/visual contents description document and an audio/visual style sheet;

FIG. 11 is a flowchart illustrating another example of an operation of the client server system; and

FIG. 12 is a diagram illustrating a construction of an apparatus that executes a process of generating an audio/visual contents description application.

### DETAILED DESCRIPTION OF THE PREFERRED EMBODIMENTS

Referring now to the drawings, wherein like reference numerals designate identical or corresponding parts throughout the several views, preferred embodiments of the present invention are described.

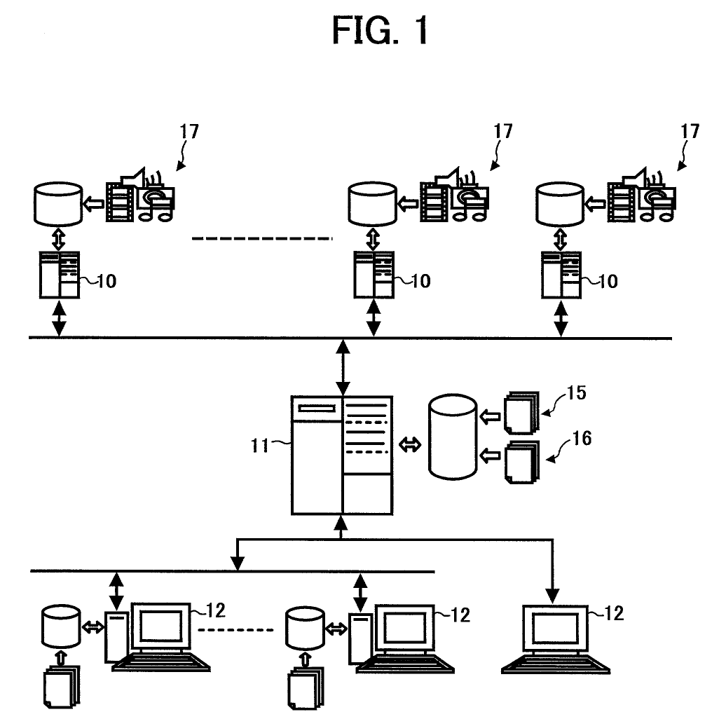

FIG. 1 a diagram illustrating a client/server system using an audio/visual style sheet of the present invention.

The client server system includes servers 10, a web server 11, and clients 12. Each server 10 stores audio/visual contents data 17. The audio/visual contents data 17 is stored as raw video, audio, or image data or as an audio/visual contents description document described with XML (or another markup language). That is, the audio/visual contents data 17 can be information contents itself. Audio/visual contents or information as used in this document includes not only still images but also video images, movies, etc.

The web server 11 receives a request from the servers 10 so as to communicate with the servers 10. In this configuration, the clients 12 need not to directly communicate with the servers 10, so that unnecessary wait times waiting for a response from the servers 10 are avoided. The web server 11 receives from the servers 10 data requested by a user and stores the data. Once the data is stored by the web server 11, a subsequent user request is executed to the data stored by the web server 11. The present invention does not require that the servers 10 and the web server 11 are separately provided as described above, and functions of the servers 10 and the web server 11 can be realized by a single server unit.

When data received from the servers 10 is processed, the web server 11 sends the processed data to a client 12. The received data is, for example, displayed by a browser of the user of the client 12. If the user issues additional requests in a dialoguing manner, the requests are either executed locally by the client 12 or by the web server 11.

The web server 11 stores an audio/visual contents description document 15 and an audio/visual style sheet 16. An audio/visual contents description document 15 includes information contents, data expressing constructional characteristics of the information contents, and descriptive information relating to a data set by the creator of the information contents or the user. An audio/visual style sheet 16 is, for example, a template that defines a process and operation executed when the user issues a specific request.

For example, when retrieving data using an image as a retrieving key, the web server 11 checks, upon receiving a request from a user, if an audio/visual style sheet 16 as a template for use in an image retrieving application exists in its own memory. When the audio/visual style sheet 16 exists, the web server 11 processes and operates an audio/visual contents description document 15 received from the server 10, according to a definition of the audio/visual style sheet 16. The audio/visual contents description document 15 and the audio/visual style sheet 16 are stored in a memory or a cache memory of the web server 11.

Each client 12 stores in its own memory tools and applications that can be used in conjunction with an audio/visual contents description application. The tools and applications are described with such languages as C, C++, Java, etc., and are called via the audio/visual contents description application displayed in a display of the client 12.

When a user sends a request for data retrieval using an image as a retrieving key, the web server 11 processes in response to the request an appropriate audio/visual contents description document 15 and an appropriate audio/visual style sheet 16, and sends processed data (i.e., the audio/visual contents description document 15 and the audio/visual style sheet 16) to a browser of the client 12. The browser uses an interface of a window system of the client 12 for displaying the received data on a display. The displayed data can be manipulated using the tools provided in the client 12. The audio/visual contents description application has a link to the tools to call an appropriate one of them according to user manipulation of buttons.

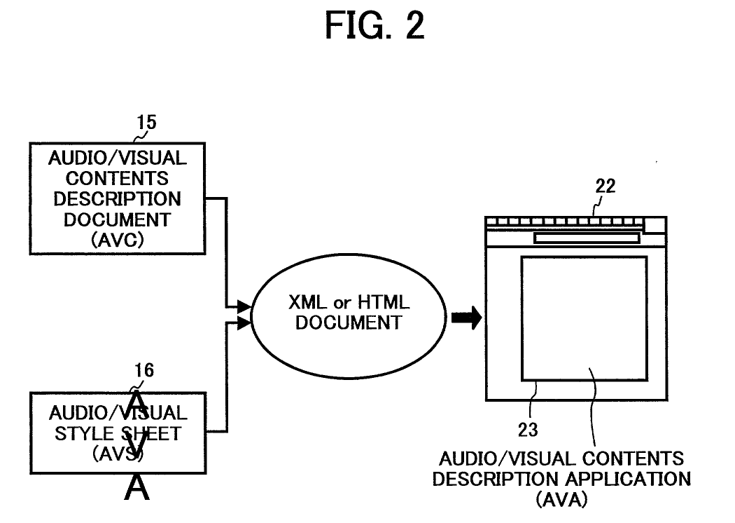

FIG. 2 is a diagram for explaining an operation of providing an audio/visual contents description application by processing an audio/visual contents description document (AVC) 15 and an audio/visual style sheet (AVS) 16.

As illustrated in FIG. 2, the audio/visual contents description document (AVC) 15 includes information for processing and the audio/visual style sheet (AVS) 16 includes information defining a display setting and a processing content for the information for processing. The web server 11 generates an XML or HTML document by processing the audio/visual style description document 15 with the audio/visual style sheet 16 and sends the generated document to a browser 22 of the client 12. The browser 22 displays the received document and provides an audio/visual contents description application 23 to the user.

More specifically, the audio/visual contents description document 15 includes metadata for explaining audio/visual contents (e.g., the title, the author, etc. of the audio/visual contents) and a structural description describing a structural aspect of the audio/visual contents. Here, the audio/visual contents description document 15 includes video information. For example, scene information describing a goal scene in a soccer match can be structured as an audio/visual contents describing document 15. The audio/visual style sheet 16 includes a design layout for displaying in a browser information of the audio/visual contents description document 15 with an audio/visual contents description application and a definition of processing contents for the information for processing, i.e, the information of the audio/visual contents description document 15. For example, when the audio/visual contents description application 23 is an image retrieving application, a retrieval button linked to a tool for performing retrieval of an image database is provided in the audio/visual contents description application 23. The tool may be one that performs, for example, checking of edges of an image in an image retrieval operation and is a program code read out from a server or a client computer to be executed.

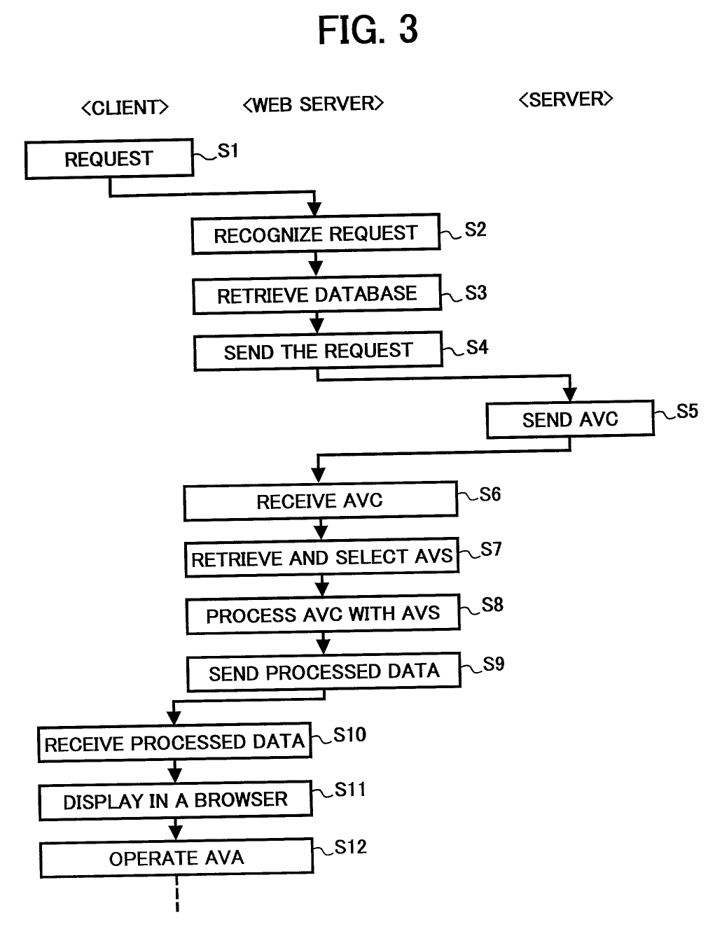

FIG. 3 is a flowchart illustrating an operation of the client server system of FIG. 1.

In step S1, a user issues a request from the client 12. For example, the user issues a request for retrieving data using an image as a retrieval key.

In step S2, the web server 11 receives the request and analyzes contents of the request so as to recognize the contents of the request. For example, the web server 11 recognizes the contents of the request as data retrieval using an image as a retrieval key.

In step S3, the web server 11 searches for a database based on the contents of the request. For example, when a retrieval subject is an image of a marine animal, the web server 11 searches the server 10 connected with the web server 11 for an image database of marine animals.

In step S4, the web server 11 sends the request to the database found in step S3.

In step S5, the server 10, upon receiving the request from the web server 11, sends a corresponding audio/visual contents description document (AVC) 15, for example a visual contents description document of the marine animals database, to the web server 11.

In step S6, the web server 11 receives the requested audio/visual contents description document (AVC) 15.

In step S7, the web server 11 searches for an audio/visual style sheet (AVS) 16 based on the contents of the request and selects an appropriate audio/visual style sheet (AVS) 16. For example, when the contents of the request is to retrieve data using a sketch image as a retrieval key, the web server 11 searches for an audio/visual style sheet (AVS) 16 that generates an image retrieval application based on the contents of the request within a memory of the web server 11, so as to select an appropriate audio/visual style sheet (AVS) 16.

In step S8, the web server 11 processes the audio/visual contents description document (AVC) 15 with the selected audio/visual style sheet (AVS) 16. A result of the processing is obtained for example in a form of an XML or HTML document.

In step S9, the web server 11 sends the processed data, such as an XML or HTML document, to the client 12.

In step S10, the client 12 receives the processed data from the web server 11.

In step S11, the client 12 displays the received data in a browser so as to provide to the user an audio/visual contents description application 23 (AVA).

In step S12, the user manipulates the audio/visual contents description application (AVA) 23 displayed in the browser. Thus, the operation of acquiring a desired audio/visual contents description application (AVA) by sending a request ends.

In the above-described operation, the web server 11 is configured to retrieve an audio/visual contents description document and an audio/visual style sheet when a request is received from a user, according to contents of the request from the user, and to perform a processing to a combination of the audio/visual contents description document and the audio/visual style sheet which have been obtained. Here, alternatively, the web server 11 can be configured such that all possible combinations of audio/visual contents description documents and audio/visual style sheets are processed, and that processed data is stored in the web server 11 in advance.

Further, the present invention does not require the servers 10 and the web server 11 to be separate as illustrated in FIG. 3, and functions of the servers 10 and the web server 11 can be realized by a single server apparatus.

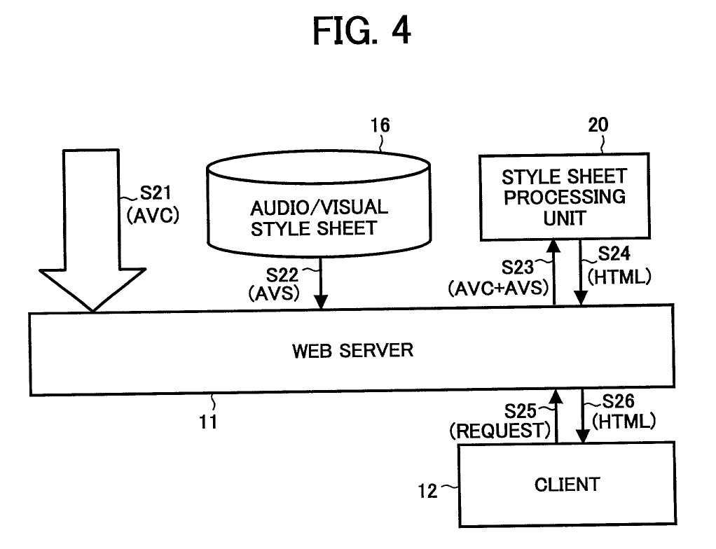

FIG. 4 is a diagram for explaining another operation of the client server system of FIG. 1. Referring to FIG. 4, a construction and an operation to process in advance all possible combinations of audio/visual contents description documents and audio/visual style sheets are described.

In operation S21, the web server 11 accesses and acquires an audio/visual contents description document 15 (AVC) of the servers 10. In operation S22, the web server 11 acquires an audio/visual style sheet (AVS) 16 applicable to the audio/visual contents description document (AVC) 15 acquired in step S21. In operation S23, the web server 11 sends the audio/visual contents description document (AVC) 15 and the audio/visual style sheet (AVS) 16 to a style sheet processing unit 20. In operation S24, the style sheet processing unit 20 processes the received audio/visual contents description document (AVC) 15 and an audio/visual sheet (AVS) 16, so as to output an HTML document. The output document can be described in any other formats than the HTML format.

The above-described processing is executed for every possible combination of an audio/visual contents description document (AVC) 15 and an audio/visual style sheet (AVS) 16, such that corresponding HTML documents are stored in the web server 11.

In operation S25, a client 12 requests from the web server 11 an audio/visual contents description application such as an image retrieval application. Upon recognizing that the request is for an image retrieval application, the web server 11 retrieves a corresponding HTML document.

In operation S26, the web server 11 sends the retrieved HTML document to the client 12. The client 12 displays the received HTML document by a browser so as to provide an audio/visual contents description application to the user.

By thus processing every possible combination of audio/visual contents description document 15 and audio/visual style sheet 16 in advance, the response speed for requests from the client 12 to the web server 11 can be enhanced.

In FIGS. 3 and 4, the audio/visual contents description document (AVC) 15 is processed according to the audio/visual style sheet (AVS) 16 at the web server 11. However, in the client server system configured as illustrated in FIG. 1, the audio/visual contents description document (AVC) 15 and the audio/visual style sheet (AVS) 16 can be sent to the client 12 without being processed at the web server 11, so that the audio/visual contents description document (AVC) 15 is processed according to the audio/visual style sheet (AVS) 16 at the client 12.

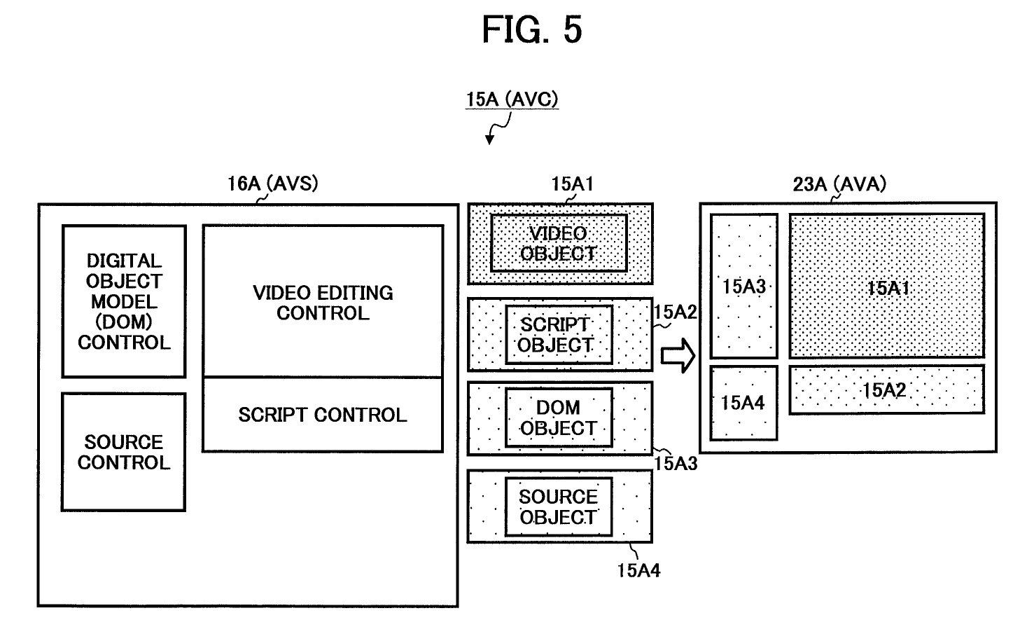

FIG. 5 is diagram illustrating an example of generating an audio/visual contents description application by a combination of an audio/visual contents description document and an audio/visual style sheet.

FIG. 5 illustrates an example of a video editing application. In FIG. 5, an audio/visual style sheet (AVS) 16A defines each display layout in a browser of a digital object model control, a video editing control, a source control, and a script control, and each processing of the controls as well. An audio/visual contents description document (AVC) 15A includes a video object 15A1, a script object 15A2, a digital object model object 15A3, and a source object 15A4. In an audio/visual contents description application (AVA) 23A, the audio/visual contents description document components 15A1-15A4 are respectively displayed according to a layout defined by the audio/visual style sheet (AVS) 16A. When a user manipulates the audio/visual contents description application (AVA) 23A by, for example, clicking a mouse, a process defined by the audio/visual style sheet (AVS) 16A is executed.

As illustrated in FIG. 5, the audio/visual style sheet (AVS) 16A is provided as a separate data file from the audio/visual contents description document (AVC) 15A. Accordingly, when changing contents of an application according to a situation, the contents can be changed by only changing the audio/visual style sheet (AVS) 16A without changing the audio/visual contents description document (AVC) 15A. Thereby, productivity in changing contents of an application is increased.

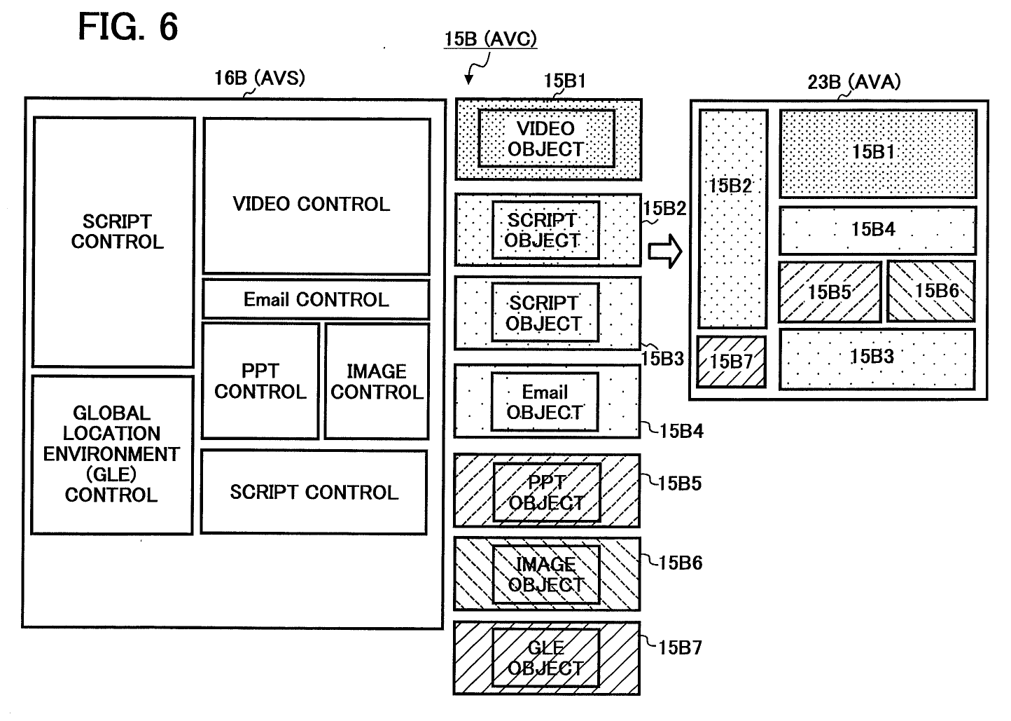

FIG. 6 is a diagram illustrating another example of generating an audio/visual contents description application by a combination of an audio/visual contents description document and an audio/visual style sheet.

FIG. 6 illustrates an example of an office document retrieval application. An audio/visual style sheet (AVS) 16B defines each display layout in a browser of a script control, a global location environment (GLE) control, a video control, an e-mail control, a PPT control, an image control, and an additional script control, and each processing of the controls as well. The audio/visual contents description document (AVC) 15B includes a video object 15B1, a script object 15B2, another script object 15B3, an e-mail object 15B4, a PPT object 15B5, an image object 15B6, and a GLE object 15B7. In an audio/visual contents description application (AVA) 23, the audio/visual contents description document (AVC) components 15B1-15B7 are respectively displayed according to a layout defined by the audio/visual style sheet (AVS) 16B. When the user manipulates the audio/visual contents description application (AVA) 23B, for example by clicking a mouse, a process defined by the audio/visual style sheet (AVS) 16B is executed.

Now, a method of generating an application by use of an audio/visual style sheet is described using a concrete example.

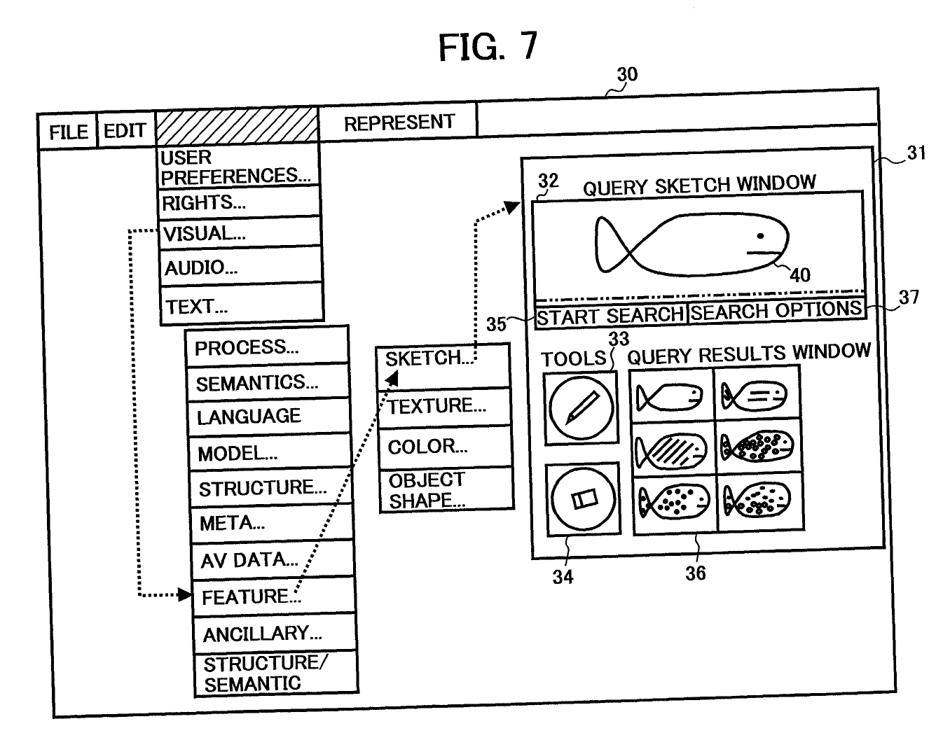

FIG. 7 is a diagram illustrating an example of an audio/visual contents description application generated by a combination of an audio/visual contents description document and an audio/visual style sheet, according to the present invention.

FIG. 7 illustrates an application user interface 30. The user can obtain a desired application by selecting an audio/visual contents description document and an audio/visual style sheet that are suitable for a need of the user via manipulation of the application interface 30.

For example, the user opens a query sketch window 31 by sequentially selecting options from menu bars of the application interface 30. In the query sketch window 31, a sketch window 32, a drawing button 33, an eraser button 34, a start search button 35, a query results display window 36, and a search options button 37 are provided.

The user draws a sketch image 40 in the sketch window 32 by using drawing tools which are activated when the drawing button 33 is clicked. For erasing a drawn image as necessary, the eraser button 34 is provided. By clicking the eraser button 34, erasing tools are activated. After completing drawing of the sketch image 40, by clicking the start search button 35, the user can search for an image similar to the sketch image 40 over a network. When a similar image is obtained, the obtained image is displayed in the query result display window 36.

A process of generating an image retrieval application capable of operating as described above by using an audio/visual contents description document and an audio/visual style sheet is next described.

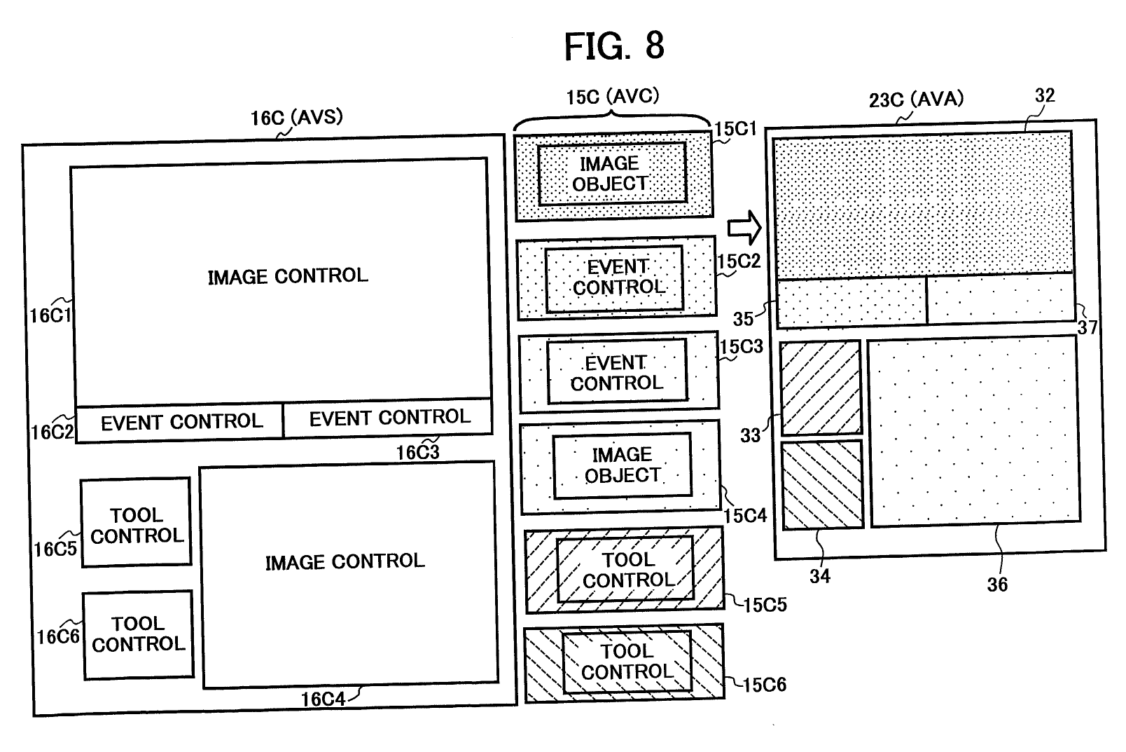

FIG. 8 is a diagram illustrating another example of generating an audio/visual contents description application by a combination of an audio/visual contents description document and an audio/visual style sheet, and illustrates an image retrieval application capable of performing an image retrieval operation as illustrated in FIG. 7.

An audio/visual contents description application (AVA) 23C corresponds to the sketch query window 31. The audio/visual contents description application (AVA) 23C is generated by processing an audio/visual description document (AVC) 15C with an audio/visual style sheet (AVS) 16C.

In the audio/visual contents description application (AVA) 23C of FIG. 8, the sketch window 32 corresponds to an image object 15C1 of the audio/visual contents description document (AVC) 15C and an image control 16C1 of the audio/visual style sheet (AVS) 16C. The drawing button 33 corresponds to a tool control 15C5 of the audio/visual contents description document (AVC) 15C and a tool control 16C5 of the audio/visual style sheet (AVS) 16C. The eraser button 34 corresponds to another tool control 15C6 of the audio/visual contents description document (AVC) 15C and another tool control 16C6 of the audio/visual style sheet (AVS) 16C. The search start button 35 corresponds to an event control 15C2 of the audio/visual contents description document (AVC) 15C and an event control 16C2 of the audio/visual style sheet (AVS) 16C. The query result display window 36 corresponds to an image object 15C4 of the audio/visual contents description document (AVC) 15C and an image control 16C4 of the audio/visual style sheet (AVS) 16C. The search options button 37 corresponds to another event control 15C3 of the audio/visual contents description document (AVS) 15C and another event control 16C3 of the audio/visual style sheet (AVS) 16C.

The image control 16C1 of the audio/visual style sheet (AVS) 16C defines the window 32 where a sketch image used for retrieval is displayed. The image control 16C4 of the audio/visual style sheet (AVS) 16C defines the query results window 36 where an image obtained as a result of the retrieval is displayed.

The event control 16C2 of the audio/visual style sheet (AVS) 16C defines an event button. The event button is linked to image characteristics provided in the standards such as MPEG-7 etc. by the audio/visual style sheet (AVS) 16. The image characteristics defined by MPEG-7 include, for example, edge characteristics. Generally, description data of image characteristics includes metadata relating to information on the title, the author, the type of an image, etc., and numerical data describing structural aspects of the image, such as an edge, a color histogram, etc. of the image.

Before sending the audio/visual style sheet (AVS) 16C and the audio/visual contents description document (AVC) 15C to a client 12, the web server 11 (FIG. 1) checks if visual descriptors, such as edge, color, and texture descriptors, are included in the audio/visual contents description document (AVC) 15C. When any of these visual descriptors exist in the audio/visual contents description document (AVC) 15C, the web server 11 relates the visual descriptor to a corresponding button displayed in a display by an audio/visual contents description application 23C (AVA).

In the example illustrated in FIG. 8, an edge descriptor is related to the start search button 35. When the start search button 35 is depressed, the edge descriptor of the sketch image 40 (FIG. 7) and the edge descriptor of an image included in the audio/visual contents description document (AVC) 15C are compared.

MPEG-7 describes physical and logical characteristics of audio/visual contents with a scheme called a Description Scheme (DS). A Segment DS, one kind of the Description Scheme, expresses a part of audio/visual contents. The Segment DS is classified into an AudioSegment DS for describing an audio information segment of audio/visual contents, a StillRegion DS for describing a still picture segment of visual contents, a MovingRegion DS for describing a moving picture segment of visual contents, and a VideoSegment DS for describing a set of video sequence frames. The StillRegion DS is suitable for image retrieval as illustrated in FIG. 7. To the StillRegion DS, three descriptors can be related, a Homogeneous Texture Descriptor describing structural characteristics of an image, such as direction, coarseness, and regularity of a pattern, a Texture Browsing Descriptor describing texture characteristics, and an Edge Histogram Descriptor describing a spatial distribution of four directional edges and one non-directional edge of an image.

Accordingly, when MPEG-7 is a linking object, the audio/visual style sheet 16C relates the above-described Edge Histogram Descriptor defined by MPEG-7 to the start search button 35 and defines each step necessary for comparing the Edge Histogram Descriptor between images to be related to the start search button 35. Thereby, in response to a button operation on the start search button 35, a process of comparing an edge descriptor of a sketch image as a retrieval key an d an edge included in an audio/visual contents description document (AVC) 15C can be started, so that an image retrieval is executed. When an image database is not one of audio/visual contents description documents that are described with an XML language including an edge descriptor calculated in advance, it is necessary to perform calculation of an Edge Histogram Description for each of the audio/visual contents description documents one by one during a retrieval process.

The event control 16C3 of the audio/visual style sheet (AVS) 16C defines an event button in which retrieval options can be set. For example, when a user desires to retrieve a marine animal similar to a manually drawn sketch image, the user can set an appropriate retrieval condition by using the event button. When the sketch image is one of a whale, by designating the title of an image as a marine animal or whale, retrieval is performed by combining retrieval according to visual characteristics of the sketch image (e.g., retrieval according to edge characteristics) and retrieval by metadata (e.g., retrieval by the title).

In MPEG-7, a title is defined with one of metadata descriptors. More specifically, information relating to generating data contents is described with a Creation Description Scheme, in which “Title” describes a title of audio/visual contents, “CreationDescription” describes information relating to what are the contents of data, where, when, why, and how the data was created, and who created the data, “Creator” describes an author of the data (an individual, a party, a group, etc.), “CreationLocation” describes a place where the data was created, “CreationDate” describes the date of creation, and “CreationMaterial” describes an apparatus used for creating the data.

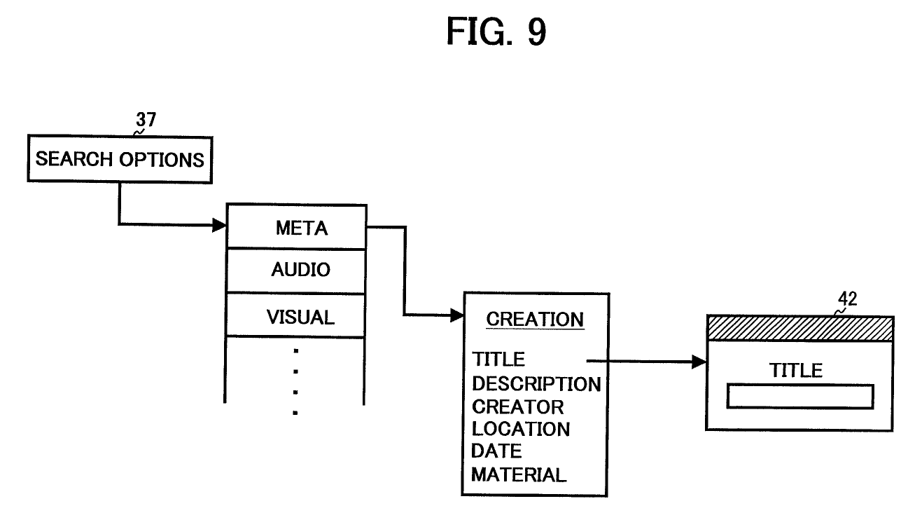

FIG. 9 is a diagram for explaining an operation of setting a title by manipulating the search options button 37.

As illustrated in FIG. 9, by manipulating the search options button 37, a user opens a menu, selects “Meta” (metadata) in the menu, and then selects “Title” in “Creation Description Scheme”, to open a title input window 42. The user inputs in the title input window 42 a title, such as, a whale, to set the title of a retrieval object.

Setting of search options is not limited to “Meta” (metadata). For example, by selecting, for example, “Visual” in the menu, visual characteristics of a retrieval object can be set. In this example, because retrieval is based on a sketch image, the default setting can be set such that retrieval is based on edge characteristics.

The tool control 16C5 of the audio/visual style sheet (AVS) 16C defines a drawing tool. That is, the audio/visual style sheet 16C (AVS) is described such that the drawing button 33 corresponding to the tool control 16C5 is linked to a program of the drawing tool. Thereby, for example, in response to a button click of the drawing button 33, the drawing tool program can be executed.

The tool control 16C6 of the audio/visual style sheet (AVS) 16C defines an eraser tool. That is, the audio/visual style sheet 16C (AVS) is described such that the eraser button 34 corresponding to the tool control 16C6 is related to an eraser tool program. Thereby, for example, in response to a button click of the eraser button 34, the eraser tool program can be executed.

The above-described tools can be provided locally in a client apparatus and can be described with such languages as C, C++, Java, etc.

Further, designation with respect to a window tool used for displaying an audio/visual contents description application (AVA) 23C may be included in an audio/visual style sheet (AVS) 16C. For example, when an audio/visual style sheet (AVS) 16C includes designation to use a Java tool kit, a browser interprets the designation when constructing an audio/visual contents description application (AVA) 23C, to display the audio/visual contents description application (AVA) 23C using the Java tool kit provided in a client apparatus 12.

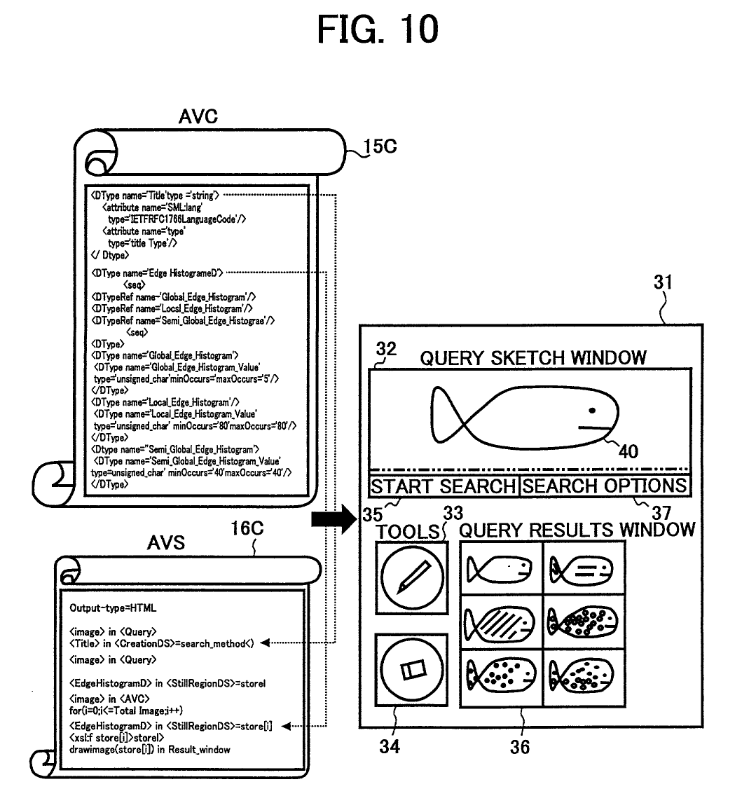

FIG. 10 is a diagram illustrating concrete examples of the audio/visual contents description document (AVC) 15C and the audio/visual style sheet (AVS) 16C.

The audio/visual contents description document (AVC) 15C includes data relating to title and edge descriptors. The audio/visual style sheet (AVS) 16C includes a definition of a process of executing retrieval in accordance with a title specified by a user. Specifically, by executing “search-method”, a web server searches for an image under the condition that the title is specified, for example, as a whale. Further, a process of executing retrieval using an edge descriptor is defined in the audio/visual style sheet (AVS) 16C. That is, by comparing “EdgeHistogram” of images of the audio/visual contents description document (AVC) 15C and that of a sketch image, a closest image is displayed by “drawimage” in the query results display window (“Result Window”) 36.

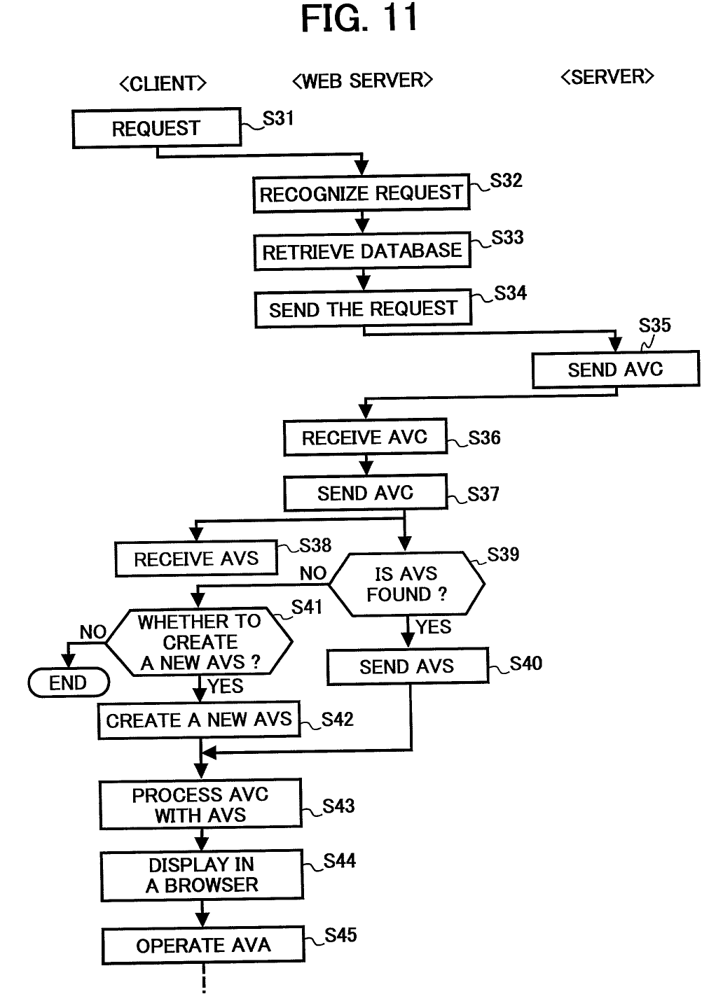

FIG. 11 is a flowchart illustrating another example of an operation of a client server system according to the present invention.

An audio/visual contents description application as illustrated in FIG. 7 may be generated in accordance with the process of FIG. 3 or a process of FIG. 11.

In step S31 of FIG. 11, a user issues a request from the client 12. In step S32, the web server 11 receives and analyzes the request to recognize contents of the request. In step S33, the web server 11 searches for a database based on the contents of the request. In step S34, the web server 11 sends the request to the database found in step S33. In step S35, the server 10 receives the request from the web server 11, and then sends a corresponding audio/visual contents description document (AVC) to the web server 11. In step S36, the web server 11 receives the requested audio/visual contents description document (AVC).

In step S37, the web server 11 sends the audio/visual contents description document (AVC) to the client 12. In step S38, the client 12 receives the audio/visual contents description document (AVC). In step S39, the web server 11 searches an audio/visual style sheet (AVS). When an audio/visual style sheet (AVS) based on the contents of the request is found, the process proceeds to step S40. When the audio/visual style sheet (AVS) is not found, the process proceeds to step S41.

In step S40, the web server 11 sends the audio/visual style sheet (AVS) to the client 12. In step S41, the client 12 determines whether to create a new audio/visual style sheet (AVS). For example, the client 12 asks the user whether to create a new audio/visual style sheet (AVS). When it is determined not to create a new audio/visual style sheet (AVS), the process ends. When it is determined to create a new audio/visual style sheet (AVS), the process proceeds to step S42.

In step S42, the user creates a new audio/visual style sheet (AVS) with the client 12. In step S43, the client 12 processes the audio/visual contents description document (AVC) with the audio/visual style sheet (AVS). The result of the processing is obtained in a form of an XML or HTML document.

In step S44, the client 12 displays processed data in a browser, so as to provide to the user an audio/visual contents description application (AVA). In step S45, the user operates the audio/visual contents description application (AVA) displayed in the browser. Thereby, an operation of acquiring a desired audio/visual contents description application (AVA) by sending a request ends.

The process illustrated in FIG. 11 differs from that of FIG. 3 in that an option is available to create a new audio/visual style sheet (AVS) when an appropriate style sheet (AVS) is not found and that the process of applying an audio/visual style sheet (AVS) to an audio/visual contents description document (AVC) is executed at the client 12 instead of the web server 11.

The place and timing to execute necessary processes, such as, in which apparatuses processing of an audio/visual contents description document (ADC) and an audio/visual style sheet (AVS) should be performed, and whether to previously perform the processing for every possible combination of the audio/visual contents description document (AVC) and the audio/visual style sheet (AVS) or to perform the processing in response to a user request, are not limited to those described above, and can be otherwise than as described above.

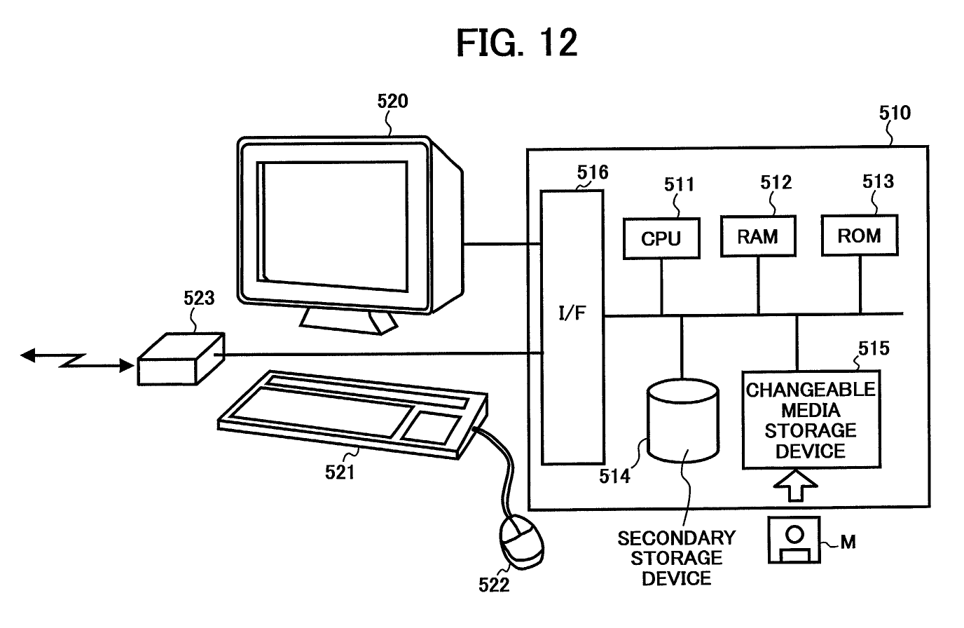

FIG. 12 is a diagram illustrating a construction of an apparatus that executes a process of generating an audio/visual contents description application according to the present invention.

As illustrated in FIG. 12, an apparatus that executes an operation of generating an audio/visual contents description application according to the present invention can be realized by a computer such as a personal computer or an engineering workstation. The apparatus illustrated in FIG. 12 serves as the web server 11 or a client 12 of FIG. 1, and generates an audio/visual contents description application.

The apparatus of FIG. 12 includes a computer 510, a display apparatus 520 connected with the computer 510, a communication apparatus 523, and an input apparatus. The input apparatus includes, for example, a keyboard 521 and a mouse 522. The computer 510 includes a CPU 511, a RAM 512, a ROM 513, a secondary storage device 514 such as a hard disc, a changeable media storage device 515, and an interface 516.

The keyboard 521 and the mouse 522 provide a user interface and input various kinds of commands for operating the computer 510 and user responses relative to requested data. The display apparatus 520 displays results of processes by the computer 510 and various data for enabling an interaction with a user when the user operates the computer 510. The communication apparatus 523 communicates with a remote place and includes, for example, a modem and a network interface.

A process of generating an audio/visual contents description application of the present invention can be provided as a computer program that can be executed by the computer 510. The computer program is stored in a storage medium M that can be attached to the changeable media storage device 515, and is loaded from the storage medium M to the RAM 512 or the secondary storage device 514 via the changeable media storage device 515. Alternatively, the computer program can be stored in a remote storage medium (not shown), and is loaded to the RAM 512 or the secondary storage device 514 via the communication apparatus 523 and the interface 516.

When the user inputs a program execution instruction via the keyboard 521 and/or mouse 522, the CPU 511 loads the program from the storage medium M, the remote storage medium, or the secondary storage device 514 to the RAM 512. The CPU 511 executes the program loaded to the RAM 512 using an unused storage area of the RAM 512 as a work area, and performs processing while interacting with the user as necessary. The ROM 513 stores a control program for controlling a basic operation of the computer 510.

The above-described computer program realizes, as illustrated in FIG. 3 or FIG. 11, retrieving and acquiring an audio/visual contents description document in response to a user request, retrieving and acquiring or creating an audio/visual style sheet, and processing the audio/visual contents description document with the audio/visual style sheet, so as to create an audio/visual contents description application. The style sheet processing unit 20 of FIG. 4 is realized as the above-described computer program.

An audio/visual style sheet is stored in the storage medium M that can be attached to the changeable storage media device 515 of FIG. 12, and is downloaded from the storage medium M onto the RAM 512 or the secondary storage medium 514 via the changeable storage media device 515. Alternatively, the audio/visual style sheet is stored in a remote storage medium (not shown), and is downloaded from the remote storage medium onto the RAM 512 or the secondary storage medium 514 via the communication apparatus 523 and the interface 516. The audio/visual style sheet may be created by the apparatus of FIG. 12 using the display apparatus 520, the keyboard 521, and the mouse 522 as necessary, so as to be stored in the secondary storage device 514 etc.

As described above, in the present invention, an application of manipulating data of multimedia information is generated according to a style sheet that includes a definition relating to a display format for data of multimedia information and a definition relating to processing of data of multimedia information. Accordingly, contents of the multimedia information and a processing and displaying format for the multimedia information can be separately managed from each other, such that even when changing the application by necessity, the application can be changed by only changing the style sheet that defines a processing and displaying format as necessary without changing a file containing the contents. By thus expanding the concept of a style sheet to displaying and processing of multimedia information, efficient generation of an application of manipulating data of multimedia information is realized, so that efficient management and processing of multimedia information can be realized.

Further, in the present invention, by processing multiple combinations of multimedia information and style sheets in advance, a user request can be quickly responded.

Furthermore, in the present invention, multimedia information and a style sheet can be acquired one by one according to a user request. In this case, multimedia information and a style sheet can be managed while maintaining separation of the multimedia information and the style sheet.

Further, in the present invention, when a style sheet is not found in response to a user request, by creating a new style sheet, accumulation of style sheets can be realized, so that plentiful applications can be accumulated.

Obviously, numerous additional modifications and variations of the present invention are possible in light of the above teachings. It is therefore to be understood that within the scope of the appended claims, the present invention may be practiced otherwise than as specifically described herein.

What is claimed as new and is desired to be secured by Letter Patent of the United States is:

1. An application generating method, comprising:
a) acquiring multimedia information that includes at least two of video data, audio data, image data, and text data and that is described with a language for structuring information;
b) acquiring a style sheet that includes a definition relating to a data display format of the multimedia information and a definition relating to data processing of the multimedia information; and
c) generating an application of manipulating data of the multimedia information by processing the multimedia information with the style sheet.

2. The method according to claim 1, wherein the steps of a), b), and c) generate a plurality of applications of manipulating data of multimedia information for a plurality of combinations of multimedia information and style sheets, the method further comprising:
receiving a user request; and
selecting an application based on the user request from among the plurality of generated applications.

3. The method according to claim 1, further comprising:
receiving a user request,
wherein multimedia information and a style sheet based on the user request are acquired in the steps of a) and b), respectively.

4. The method according to claim 1, the step of b) further including searching for a style sheet based on a user request, and generating a new style sheet when the style sheet based on the user request is not found.

5. The method according to claim 1, further comprising:
displaying the application in a browser used by a user; and
executing data processing defined by the style sheet in based on an operation by the user relative to the application.

6. An application generating apparatus, comprising:
a multimedia information acquiring mechanism configured to acquire multimedia information that includes at least two of video data, audio data, image data, and text data and that is described with a language for structuring information;
a style sheet acquiring mechanism configured to acquire a style sheet that includes a definition relating to a data display format of the multimedia information and a definition relating to data processing of the multimedia information; and
an application generating mechanism configured to generate an application of manipulating data of the multimedia information by processing the multimedia information with the style sheet.

7. The apparatus according to claim 6,
the multimedia information acquiring mechanism, the style sheet acquiring mechanism, and the application generating mechanism generating a plurality of applications of manipulating data of multimedia information for a plurality of combinations of multimedia information and style sheets, the apparatus further comprising:
a user request receiving mechanism configured to receive a user request; and
an application selection mechanism configured to select an application based on the user request from among the plurality of generated applications.

8. The apparatus according to claim 6, further comprising:
a user request receiving mechanism configured to receive a user request;
wherein the multimedia information acquiring mechanism and the style sheet acquiring mechanism acquire multimedia information and a style sheet based on the user request.

9. The apparatus according to claim 6, the style sheet acquiring mechanism further including a style sheet searching mechanism configured to search for a style sheet based on a user request, and a new style sheet generating mechanism based on generate a new style sheet when the style sheet corresponding to the user request is not found.

10. The apparatus according to claim 6, further comprising:
a displaying mechanism configured to display the application in a browser used by a user; and
a data processing executing mechanism configured to execute the data processing defined by the style sheet based on an operation by the user relative to the application.

11. A system comprising:
a server configured to acquire multimedia information that includes at least two of video data, audio data, image data, and text data and that is described with a language for structuring information and a style sheet that includes a definition relating to a data display format of the multimedia information and a definition relating to data processing of the multimedia information; and
a client configured to send a request to the server and to display an application of manipulating data of the multimedia information received from the server in accordance with data received from the server in response to the request,
wherein the application is generated by processing the multimedia information with the style sheet.

12. The system according to Claim 11, wherein the server is further configured to generate the application by processing the multimedia information with the style sheet and sending the application to the client.

13. The system according to claim 11, wherein the client is further configured to receive the multimedia information from the server and the style sheet and processing the multimedia information with the style sheet.

14. The system according to Claim 11, wherein the server is further configured to receive the multimedia information from a remote server.

15. An information structuring method, comprising:
recording a style sheet for multimedia information including at least two of video data, audio data, image data, and text data and described with a language for structuring information, the style sheet including a definition relating to a data display format of the multimedia information and a definition relating to data processing of the multimedia information.

16. An information structuring apparatus, comprising:
a unit configured to record a style sheet for multimedia information including at least two of video data, audio data, image data, and text data and described with a language for structuring information, the style sheet including a definition relating to a data display format of the multimedia information and a definition relating to data processing of the multimedia information.

17. A machine readable recording medium including a program for controlling a computer so as to execute steps of:
acquiring multimedia information that includes at least two of video data, audio data, image data, and text data and that is described with a language for structuring information;
acquiring a style sheet that includes a definition relating to a data display format of the multimedia information and a definition relating to data processing of the multimedia information; and
generating an application of manipulating data of the multimedia information by processing the multimedia information with the style sheet.

18. A machine readable recording medium including a style sheet that controls a computer to generate an application of manipulating data of multimedia information including at least two of video data, audio data, image data, and text data and described with a language for structuring information, by executing steps of:
setting a data display format of the multimedia information; and
setting data processing of the multimedia information.

19. An application generating apparatus, comprising:
first acquiring means for acquiring multimedia information that includes at least two of video data, audio data, image data, and text data and that is described with a language for structuring information;
second acquiring means for acquiring a style sheet that includes a definition relating to a data display format of the multimedia information and a definition relating to data processing of the multimedia information; and
generating means for generating an application of manipulating data of the multimedia information by processing the multimedia information with the style sheet.

20. The apparatus according to claim 19, the first and second acquiring means and the generating means generating a plurality of the applications for a plurality of combinations of multimedia information and style sheets, the apparatus further comprising:
means for receiving a user request; and
means for selecting an application based on the user request from among the plurality of generated applications.

21. The apparatus according to claim 19, further comprising:
means for receiving a user request;
wherein the first and second acquiring means acquire multimedia information and a style sheet based on with the user request.

22. The apparatus according to claim 19, the second acquiring means further including means for searching for a style sheet based on a user request, and means for generating a new style sheet when the style sheet based on the user request is not found.

23. The apparatus according to claim 19, further comprising:
means for displaying the application in a browser used by a user; and
means for executing the data processing defined by the style sheet in accordance with an operation by the user relative to the application.

24. A system comprising:
means for acquiring multimedia information that includes at least two of video data, audio data, image data, and text data and described with a language for structuring information and a style sheet including a definition relating to a data display format of the multimedia information and a definition relating to data processing of the multimedia information; and
means for sending a request to the means for acquiring and for displaying an application of manipulating data of the multimedia information received from the means for acquiring based on data received from the means for acquiring in response to the request,
wherein the application is generated by processing the multimedia information with the style sheet.

25. An information structuring apparatus, comprising:
means for recording a style sheet for multimedia information including at least two of video data, audio data, image data, and text data and described with a language for structuring information, the style sheet including a definition relating to a data display format of the multimedia information and a definition relating to data processing of the multimedia information.
